(19) United States
(12) Patent Application Publication
(10) Pub. No.: US 2024/0039673 A1
(43) Pub. Date: Feb. 1, 2024

(54) SYSTEMS AND METHODS FOR NETWORK ENERGY SAVING

(71) Applicant: Samsung Electronics Co., Ltd., Suwon-si (KR)

(72) Inventors: Liang HU, San Diego, CA (US); Jung Hyun BAE, San Diego, CA (US); Philippe Jean Marc Michel SARTORI, Naperville, IL (US); Hoda SHAHMOHAMMADIAN, San Diego, CA (US)

(21) Appl. No.: 18/353,032

(22) Filed: Jul. 14, 2023

Related U.S. Application Data
(60) Provisional application No. 63/393,659, filed on Jul. 29, 2022.
(60) Provisional application No. 63/419,263, filed on Oct. 25, 2022.
(60) Provisional application No. 63/465,477, filed on May 10, 2023.

(51) Int. Cl. H04L 5/00; H04W 72/23

(52) U.S. Cl. CPC H04L 5/0051; H04W 72/23

(57) ABSTRACT

A system and a method are disclosed for network energy saving. In one embodiment the method includes: receiving, by a User Equipment (UE), a Channel State Information reference signal (CSI-RS) transmitted through a first plurality of antenna ports; generating, by the UE, a first channel property indicator for a first subset of the first plurality of antenna ports, based on the CSI-RS; and generating, by the UE, a second channel property indicator for a second subset of the first plurality of antenna ports, based on the CSI-RS, wherein the second subset is different from the first subset.

### CROSS-REFERENCE TO RELATED APPLICATION

This application claims the priority benefit under 35 U.S.C. § 119(e) of U.S. Provisional Application No. 63/393,659, filed on Jul. 29, 2022, of U.S. Provisional Application No. 63/419,263, filed on Oct. 25, 2022, and of U.S. Provisional Application No. 63/465,477, filed on May 10, 2023, the disclosure of each of which is incorporated by reference in its entirety as if fully set forth herein.

### TECHNICAL FIELD

The disclosure generally relates to wireless communications. More particularly, the subject matter disclosed herein relates to improvements to systems and methods for operating a wireless network with reduced power consumption.

### SUMMARY

Wireless networks continue to grow with increased user adoption of wireless devices, and the number of devices served by a network node (gNB) may, at times, be large. This may result in high power consumption if the network node uses all of its RF chains at all times.

To solve this problem, the network node may at various times operate with only a subset of its RF chains active.

One issue with the above approach is that a user device (or User Equipment (UE)) may be handicapped in communicating with the network node unless it has an estimate of the channel corresponding to gNB operation with some RF chains disabled.

To overcome these issues, systems and methods are described herein for allowing a UE to perform channel characterization for multiple sub-configurations of the gNB (e.g., for multiple subsets of antenna ports of the gNB).

The above approach improves on previous methods because it allows a UE to calculate various channel properties, and channel property indicators, for the channel corresponding to gNB operation with some RF chains disabled.

According to an embodiment of the present disclosure, there is provided a method including: receiving, by a User Equipment (UE), a Channel State Information reference signal (CSI-RS) transmitted through a first plurality of antenna ports; generating, by the UE, a first channel property indicator for a first subset of the first plurality of antenna ports, based on the CSI-RS; and generating, by the UE, a second channel property indicator for a second subset of the first plurality of antenna ports, based on the CSI-RS, wherein the second subset is different from the first subset.

In some embodiments, the first subset is associated with an index.

In some embodiments, the method further includes: receiving, by the UE, in a Downlink Control Information (DCI), a trigger state identifier; and determining, based on the trigger state identifier, the first subset and the second subset.

In some embodiments, the DCI is a group common DCI.

In some embodiments, the UE is preconfigured with an association mapping the trigger state identifier to the first subset and the second subset.

In some embodiments, the method further includes: receiving, by the UE, in a Media Access Control Control Element (MAC CE), a trigger state identifier; and determining, based on the trigger state identifier, the first subset and the second subset.

In some embodiments, the UE is preconfigured with an association mapping the trigger state identifier to the first subset and the second subset.

In some embodiments, the method further includes: receiving, by the UE, in a Downlink Control Information (DCI), a trigger state identifier; determining, based on the trigger state identifier, the first subset; and receiving, by the UE, a Physical Downlink Shared Channel (PDSCH) transmitted over the first subset.

In some embodiments, the method further includes: receiving, by the UE, from a network node (gNB), a trigger state identifier; determining, based on the trigger state identifier, the first subset and the second subset; and reporting, by the UE, the first channel property indicator and the second channel property indicator.

In some embodiments, the method further includes: receiving, by the UE, in a Media Access Control control element (MAC CE), a trigger state identifier; determining, based on the trigger state identifier, the first subset; and receiving, by the UE, a Physical Downlink Shared Channel (PDSCH) transmitted over the first subset.

According to an embodiment of the present disclosure, there is provided a User Equipment (UE) including: one or more processors; and a memory storing instructions which, when executed by the one or more processors, cause performance of: receiving a Channel State Information reference signal (CSI-RS) transmitted through a first plurality of antenna ports; calculating a first channel property indicator for a first subset of the first plurality of antenna ports, based on the CSI-RS; and calculating a second channel property indicator for a second subset of the first plurality of antenna ports, based on the CSI-RS, wherein the second subset is different from the first subset.

In some embodiments, the first subset is associated with an index.

In some embodiments, the instructions, when executed by the one or more processors, further cause performance of: receiving, by the UE, in a Downlink Control Information (DCI), a trigger state identifier; and determining, based on the trigger state identifier, the first subset and the second subset.

In some embodiments, the DCI is a group common DCI.

In some embodiments, the UE is preconfigured with an association mapping the trigger state identifier to the first subset and the second subset.

In some embodiments, the instructions, when executed by the one or more processors, further cause performance of: receiving, by the UE, in a Media Access Control control element (MAC CE), a trigger state identifier; and determining, based on the trigger state identifier, the first subset and the second subset.

In some embodiments, the UE is preconfigured with an association mapping the trigger state identifier to the first subset and the second subset.

In some embodiments, the instructions, when executed by the one or more processors, further cause performance of: receiving, by the UE, in a Downlink Control Information (DCI), a trigger state identifier; determining, based on the trigger state identifier, the first subset; and receiving, by the UE, a Physical Downlink Shared Channel (PDSCH) transmitted over the first subset.

In some embodiments, the instructions, when executed by the one or more processors, further cause performance of: receiving, by the UE, from a network node (gNB), a trigger state identifier; determining, based on the trigger state identifier, the first subset and the second subset; and reporting, by the UE, the first channel property indicator and the second channel property indicator.

According to an embodiment of the present disclosure, there is provided a User Equipment (UE) including: means for processing; and a memory storing instructions which, when executed by the means for processing, cause performance of: receiving a Channel State Information reference signal (CSI-RS) transmitted through a first plurality of antenna ports; calculating a first channel property indicator for a first subset of the first plurality of antenna ports, based on the CSI-RS; and calculating a second channel property indicator for a second subset of the first plurality of antenna ports, based on the CSI-RS, wherein the second subset is different from the first subset.

### BRIEF DESCRIPTION OF THE DRAWINGS

In the following section, the aspects of the subject matter disclosed herein will be described with reference to exemplary embodiments illustrated in the figures, in which:

FIG. 1 is a schematic drawing of high load and low load configurations, according to an embodiment;

FIG. 2 is a flowchart of a method, according to an embodiment;

FIG. 3 is a flowchart of a method, according to an embodiment;

FIG. 4 is a flowchart of a method, according to an embodiment;

FIG. 5 is a chart of Transmission Configuration Indication (TCI) states, according to an embodiment;

FIG. 6A is an antenna port utilization diagram, according to an embodiment;

FIG. 6B is an antenna port utilization diagram, according to an embodiment;

FIG. 7A is a flowchart of a method, according to an embodiment;

FIG. 7B is a flowchart of a method, according to an embodiment; and

FIG. 8 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. As used herein, the term “or” should be interpreted as “and/or”, such that, for example, “A or B” means any one of “A” or “B” or “A and B”.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

With the ever-increasing demand for data in cellular systems, the power consumption of networks has been increasing and has become a significant operational expense for deployed networks. This is becoming a major concern for operators. Thus, for New Radio (NR), the 3^{rd} Generation Partnership Project (3GPP) has investigating how to reduce the power consumption at the network side with a study item in Rel-18. This is a new area of investigation for 3GPP: up to this point, while tremendous efforts were conducted to reduce the UE power consumption in order to maximize battery life, network consumption had been largely ignored.

One particular area where energy savings may be achieved is by reducing the number of antenna panels a network node (gNB) uses: typically, the RF components and antennas of a base station are sized for high traffic demand. There are typically multiple antenna panels deployed at a gNB to, e.g., perform multi-user, multiple input, multiple output (MU-MIMO). Being able to turn off the RF chains associated with one antenna panel when the traffic demand is low may significantly reduce the base station power consumption.

Turning antenna panels on or off may be done with some level of UE involvement. For instance, if a panel is turned off, this may change the measurements and reporting the UE needs to perform. While the current standard allows for some changes, the current mechanisms are cumbersome and require significant signaling.

This disclosure includes mechanisms at the UE side to perform dynamic antenna port adaptation in order to turn antenna panels on or off.

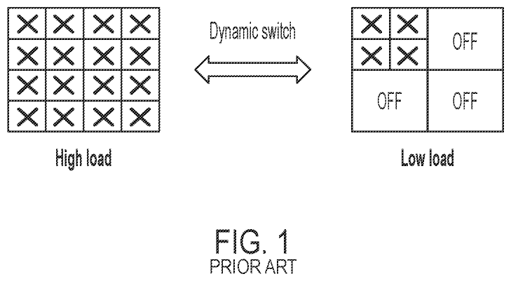

FIG. 1 is an illustration of dynamic antenna port adaptation based on cell load according to the prior art. In gNBs with active antenna systems, there may be a large number of antennas and transceiver chains. This enables the system to provide maximum system capacity by using spatial processing to perform, e.g., beamforming or MU-MIMO. The cost of having a large number of RF chains may include high power consumption. Thus, when the traffic demand is low, it may be advantageous for the gNB to turn off some transceiver chains, and it may therefore be advantageous for the gNB to be able to dynamically turn on or off unnecessary circuits depending on the load experienced by the gNB, the link quality experienced by one or more of the UEs that are in communication with the gNB, and throughput demands.

Dynamic antenna port adaption may rely on UE assistance for turning on or off transceiver chains. However, this may consume significant energy or signaling both for the UE and for the network, since the network may need to configure the UE with high-rate periodic Channel State Information (CSI) transmissions and reports, or with high-rate polling of aperiodic reports. For example, to enable the network to decide which antenna port to turn on or off, the gNB may request each serving UE to frequently measure and report the Channel State Information reference signal (CSI-RS) (possibly with multiple different CSI-RS resource mappings). In contrast, in legacy New Radio (NR), the gNB only requests a specific serving UE to perform the measurement and reporting of the CSI-RS with a configured CSI-RS resource mapping when it is needed. Thus, there is a need for new methods for signaling reduction in CSI reporting framework.

When the gNB initiates an antenna setup reconfiguration, it may make the current CSI-RS resource mapping configurations invalid. An RRC reconfiguration of the UE is possible, but requires high energy consumption because of the additional overhead, and high latency. Thus, it may be advantageous to handle CSI-RS reconfiguration at the UE without going through the existing legacy RRC reconfiguration procedure.

In some embodiments, such solutions for joint antenna port adaptation are extended across multiple transmission and reception points (mTRP). mTRP operation has been defined using an antenna port mechanism, and multiple non-zero power (NZP) CSI-RS resources may be configured in a CSI-RS resource set, where a NZP CSI-RS resource corresponds to a TRP. In mTRP deployment, UEs are served by multiple TRPs and a port selection or adaptation solution may be extended by each UE for each TRP (except joint transmission).

Antenna port adaptation or selection may also be done across mTRP and ports that are not selected by UEs may be switched off per TRP. However, in the current specification, the antenna port adaptation or selection across TRPs is not specified. Therefore, mechanisms may be employed for antenna port adaptation or selection across TRPs. For example, once some antenna ports of a TRP have been switched off, these antenna ports will not be available for CSI measurements. Thus, methods may be implemented to enable antenna port adaptation to be performed across mTRP with an on and off switching mechanism, for m-TRP energy saving operation.

To solve the issues described above, systems and/or methods disclosed herein include techniques including (i) signaling reduction in CSI reporting framework for dynamic antenna port adaptation, (ii) methods for efficient configuring and activating CSI-RS resource mapping configuration, (iii) joint antenna port and mTRP adaptation (iv) TxRU adaptation when the number of antenna ports does not change, (v) light-weighted methods that allow the UE to provide CSI feedback for different port and TxRU muting patterns, and (vi) spatial adaptation only for PDSCH but not references signals.

Signaling reduction in CSI reporting framework for dynamic antenna port adaptation may be performed as follows. Enabling dynamic antenna ports adaptation may involve active UEs frequently making CSI-RS measurements and the gNB performing frequent re-configurations of CSI-RS resource mapping with different numbers of antenna ports.

In one extreme case, 1) the existing measurements that UE capability is able to do may be obtained according to legacy procedure, and, as such, all of the complexity of deciding the optimal antenna port adaptation may be incorporated into the gNB side. In such an embodiment, no specification change is needed and no new UE assistance is needed. In another extreme case, 2) the gNB requests each UE to measure and report all possible CSI-RS resource mapping configurations (according to list of CSI-RS resource mapping configurations in TS 38.214), and the gNB makes the optimal decision; this may be impractical for UE implementation. In some embodiments, therefore, a solution is implemented that has reasonable CSI-RS measurements and report signaling, but still allows the gNB to make a reasonably good decision on antenna port adaptation.

Dynamic antenna port adaptation for network energy saving requires these two constraints to be achieved without excessive UE power consumption. In addition, it may be advantageous to minimize the specification changes, and to reuse the existing CSI-RS framework as much as possible.

On a high level, some of the antenna ports may be turned off, when UEs are close to the gNB with good signal to interference and noise ratio (SINR), or when the cell load is low or medium and thus the capacity which is provided by the higher number of antennas is underutilized. It is therefore highly desirable for the gNB to be able to dynamically turn on or off unnecessary circuits depending on the gNB's load, the UE's link quality, as well as the throughput demands. Local rules such that each UE may autonomously adapt suitable CSI-RS resource mappings to be measured and report to gNB, depending on the UE's local measurements, without the need of gNB's frequent RRC reconfigurations, may be adopted.

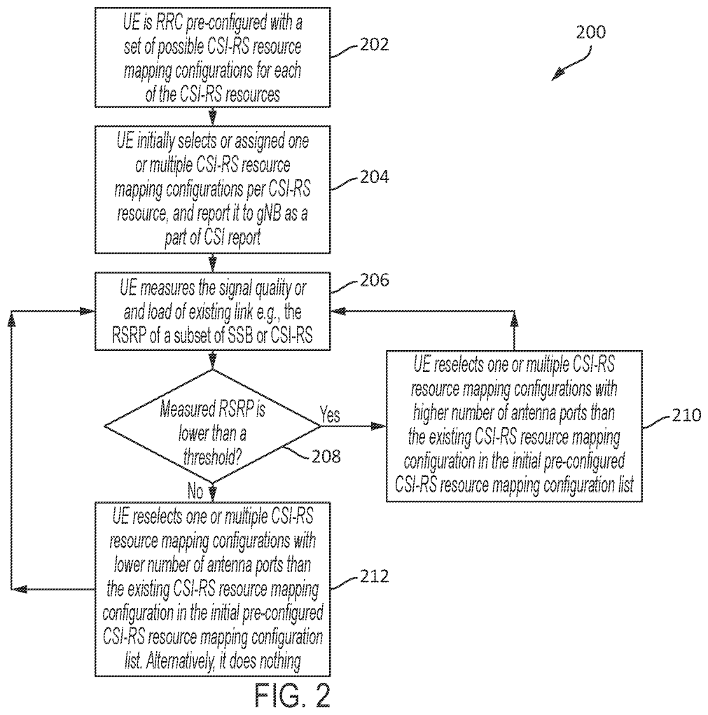

According to a “Preconfigured Set” process, the UE is (pre)configured with multiple CSI-RS resource mappings per CSI-RS resource. The Preconfigured Set process is described below, including in process 200 of FIG. 2, according to various embodiments.

Process 200 begins at step 202, wherein on top of the legacy CSI framework, each UE is RRC pre-configured by the gNB with a set of candidate CSI-RS resource mapping configurations for each of its configured CSI-RS resources in CSI-ResourceConfig. The “CSI-RS resource” here is referred by a CSI-RS resource set which is referred by CSI-ResourceConfig which is referred by CSI-ReportConfig in which a UE is required to report a channel property indicator such as RI/PMI/CQI, with the hierarchy as shown in the background section.

As used herein, a “channel property indicator” is a characteristic of a channel between a gNB and a UE, such as a Rank Indicator (RI), a Precoding Matrix Indicator (PMI), or Channel Quality Information (CQI). To have multiple resource mappings per CSI-RS resource at level 4 of the hierarchy, each of candidate CSI-RS resource mapping configurations has an associated index, but the UE does not immediately measure or report on any of them. Alternatively, multiple resource mappings may be at level 2 of the hierarchy, where each of NZP-CSI-RS-ResourceSets may have different CSI-RS resource mappings and may be activated by the gNB on demand. For example, the legacy NZP-CSI-RS-ResourceSet has one CSI-RS resource mapping, and an additional new NZP-CSI-RS-ResourceSet has another CSI-RS resource mapping. Alternatively, multiple resource mappings may be at level 3 of the hierarchy, where each NZP-CSI-RS-Resource in the resource set may have a different CSI-RS resource mappings and may be activated by gNB on demand.

At step 204, the UE (i) initially autonomously selects, either randomly or based on local measurement, or assigned by the gNB, one or more CSI-RS resource mapping configurations, (ii) reports the selected CSI-RS resource mapping configurations, and (iii) measures and reports the legacy defined UE measurements e.g., CSI-RS resource indicator (CRI), RI, PMI and CQI over its selected CSI-RS resource mapping configurations to the gNB. The report of this resource mapping index is a new part of the CSI-RS report which is a new Radio Resource Control (RRC) message information element (IE). In order to report the selected CSI-RS resource mapping configurations, the reportQuantity IE in the CSI-report Config IE may be added by an additional information element named “Selected CSI-RS resource mapping configuration index”. Additionally, the UE may start the above process only when it has received an activation command by the gNB via Downlink Control Information (DCI) or Media Access Control Control Element (MAC CE). The DCI may be a group common DCI or UE specific DCI. For a UE specific DCI, it may be one additional bit in the “CSI Request” field of DCI 0_1. The activation/deactivation command may be a 1-bit flag in the DCI or MAC CE. Without activation or with deactivation, the UE may just perform the legacy CSI-RS measurement and report.

At step 206, the UE additionally measures the quality of the existing link. For example, the UE may measure the Reference Signals Received Power (RSRP) or the Reference Signal Received Quality (RSRQ) or the SINR of a subset of the Synchronization Signal Block (SSB) signals or a subset of configured 1 or 2 port CSI-RS signals within the NZP-CSI-RS-ResourceSet of the CSI-reportConfig with reportQuantity set to “cri-RSRP” or “ssb-Index-RSRP”, or the RSSI over a pre-defined measurement time window. There may be different ways to determine the subset of SSB signals or CSI-RS signals for RSRP measurement. For example, the gNB may explicitly indicate this subset to a UE via RRC configuration, and there may be a one-to-one mapping between a CSI-RS or SSB used for RSRP/RSRQ/SINR evaluation and a CSI-RS in each CSI-ReportConfig for RI/PMI/CQI reporting. In this way, the UE will only measure the corresponding CSI-RS or SSB signal for evaluating RSRP/RSRQ/SINR, and this corresponding CSI-RS or SSB signal may be mapped to a CSI-RS signal used for RI/CQI/PMI reporting. Alternatively, a UE may implicitly utilize the source QCL-RS of CSI-RS in each report configuration for RI/PMI/CQI reporting as the source QCL-RS for evaluation of RSRP/RSRQ/SINR. In this case, a UE may expect that there is only one source QCL-RS in each CSI-RS resource set used for RI/PMI/CQI reporting. Or, if there are multiple source QCL-RSs in each CSI-RS resource set, e.g., in an mTRP scenario, the UE will evaluate the RSRP/RSRQ/SINR of the multiple source RSs for each of the possible mTRP transmission hypotheses. For CSI-RSRP determination, CSI reference signals transmitted on antenna port 3000 according to TS 38.211 (promulgated by the 3^{rd} Generation Partnership Project) may be used. If CSI-RSRP is used for L1-RSRP, CSI reference signals transmitted on antenna ports 3000, 3001 may be used for CSI-RSRP determination. The Received Signal Strength Indicator (RSSI), includes the linear average of the total received power (in watts (W)) observed only in configured orthogonal frequency division multiplexing (OFDM) symbols and in the configured measurement bandwidth over N resource blocks corresponding to measurement bandwidth with the center frequency of configured absolute radio-frequency channel number (ARFCN), by the UE from all sources, including for example co-channel serving and non-serving cells, adjacent channel interference, and thermal noise.

At step 208, it is determined if the measured RSRP/RSRQ/SINR of a subset of the SSB signals or a subset of configured 1 or 2 port CSI-RS signals within the NZP-CSI-RS-ResourceSet of the CSI-reportConfig with reportQuantity set to “cri-RSRP” or “ssb-Index-RSRP” is lower than a threshold. The threshold may be either pre-determined or RRC_configured, for example, thus, it signifies that the UE is close to the cell edge. The “subset” may be determined as in step 206 above. Then the UE reselects one or more than one CSI-RS resource mapping configurations for one or multiple of the CSI-reportConfigs for RI/PMI/CQI reporting with higher number of antenna ports than the existing CSI-RS resource mapping configuration in the pre-configured CSI-RS resource mapping configuration list (if there exists at least one configuration with a higher number of antenna ports in the list, otherwise the UE does nothing), and measures and reports as it does in step 204.

Otherwise, if the measured RSRP/RSRQ/SINR of a subset of the SSB signals or a subset of configured 1 or 2 port CSI-RS signals within the NZP-CSI-RS-ResourceSet of the CSI-reportConfig with reportQuantity set to “cri-RSRP” or “ssb-Index-RSRP”” is larger than the threshold, then, at step 212, the UE (i) reselects one or more than one CSI-RS resource mapping configurations with a lower number of antenna ports than the existing CSI-RS resource mapping configuration from the pre-configured CSI-RS resource mapping configurations (if there exist at least one configuration with lower number of antenna ports in the list, otherwise UE does nothing) for one or multiple of the CSI-reportConfigs for RI/PMI/CQI reporting, and (ii) measures and reports as it does in step 204. Alternatively, to save UE power consumption, when the measured RSRP/RSRQ/SINR of a subset of the SSB signals or a subset of configured 1 or 2 port CSI-RS signals within the NZP-CSI-RS-ResourceSet of the CSI-reportConfig with reportQuantity set to “cri-RSRP” or “ssb-Index-RSRP” is either lower or larger than a threshold, the UE continues the CSI measurement and reporting via the existing CSI-RS resource mapping configuration per CSI-reportConfig for RI/PMI/CQI reporting.

Alternatively, if the measured rank indicator (RI) of the configured CSI-RS in the report configuration for RI/PMI/CQI reporting is larger than the previous reported one, then the UE (i) reselects one or more than one CSI-RS resource mapping configurations with a higher number of antenna ports than the existing CSI-RS resource mapping configuration in the initial pre-configured CSI-RS resource mapping configuration list, and (ii) measures and reports as it does in step 204. Otherwise, if the measured rank indicator in the selected CRI is smaller than the previous reported one, then the UE (i) reselects one or more than one lower number of antenna ports CSI-RS resource mapping configurations than the existing CSI-RS resource mapping configuration in the pre-configured CSI-RS resource mapping configuration, and (ii) measures and reports as it does in step 204. Alternatively, to save UE power consumption, when the measured RI is either lower or larger than a threshold, the UE continues the CSI measurement and reporting via the existing CSI-RS resource mapping configuration.

Alternatively, if the measured RSSI is larger than a threshold, it may indicate that the cell load may be higher than before. Thus, the UE (i) reselects one or more than one CSI-RS resource mapping configurations with higher number of antenna ports than the existing CSI-RS resource mapping configuration in the initial pre-configured CSI-RS resource mapping configuration list, and (ii) measures and reports as it does in step 204. Otherwise, if the measured RSSI is smaller than the threshold, it may indicate that the cell load may be smaller than before. Then the UE (i) reselects one or more than one lower number of antenna ports CSI-RS resource mapping configurations than the existing CSI-RS resource mapping configuration in the pre-configured CSI-RS resource mapping configuration, and (ii) measures and reports as it does in step 204. Otherwise, if the measured RSSI is close to or equal to the threshold, the UE continues measuring the existing CSI-RS resource mapping configuration. Alternatively, to save UE power consumption, when the measured RSSI is either lower or larger than a threshold, UE continues the CSI measurement and report via the existing CSI-RS resource mapping configuration.

At step 210, in response to a determination that the measured RSRP is lower than a threshold, the UE continuously reselects one or more CSI-RS resource mapping configurations with a higher number of antenna ports, until the measured RSRP/RSRQ/SINR value is close to or equal to the threshold. For example, the UE may optionally continuously measure the SSB and the CSI-RS SINR/RSRP/RSRQ of the link, if SINR/RSRP/RSRQ is still below the threshold. If the SINR is above the threshold, then the UE continuously reselects one or more CSI-RS resource mapping configurations with a lower number of antenna ports, until the measured RSRP/RSRQ/SINR value is close to or equal to the threshold. In this way, the antenna port adaptation mimics the link adaptations. The threshold may be a function of required data rate or other key performance indicators (KPIs) per UE, which may be RRC pre-configured by the gNB.

Alternatively, at step 212, in response to a determination that the measured RSRP is not lower than a threshold, the UE continuously reselects one or more CSI-RS resource mapping configurations with a lower number of antenna ports, until measured RSSI is close to or equal to the threshold. For example, the UE may continuously measure the RSSI of the link over a pre-defined measurement time window. If measured RSSI is still below the threshold, it indicates the cell load is low, and thus the cell load is getting higher, and the UE continuously reselects one or more CSI-RS resource mapping configurations with a higher number of antenna ports, until measured RSSI is close to or equal to the threshold.

Upon receiving a CSI-report of all serving UEs, the gNB may decide to adapt or reconfigure the antenna ports, and possibly activate or re-configure each of the UEs with new CSI-RS resource mapping configurations.

FIG. 2 (which shows an enhanced CSI reporting solution based on measured RSRP) thus illustrates techniques in which the enhanced CSI report is based on UE measured RSRP of SSB or existing CSI-RS signal.

The advantage of such an approach is that this scheme may reduce the overhead of the gNB performing frequent reconfigurations or activation of the CSI-RS resource mapping configuration per UE since the UE self-decides which CSI-RS resource mapping configuration to measure and report. It may also minimize the UE CSI-RS measurement and reporting overhead or the need to blindly measure and report many CSI-RS resource mapping configuration simultaneously. The key in this scheme is the local rule specifying how the UE selects the CSI-RS resource mapping configuration locally: in the Preconfigured Set process, it is based on measured link quality or cell load. These link quality or cell load thresholds may be configured and indicated by the network through RRC signaling.

The network may decide that, for example, the higher the SINR of the link, the larger the number of antenna ports per CSI-RS resource mapping configuration needed at both the gNB and the UE.

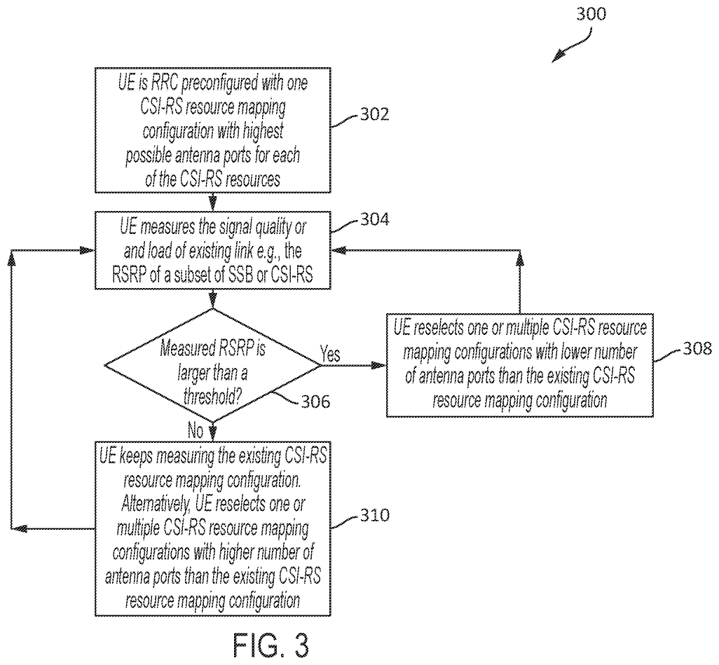

A solution referred to herein as a “Maximum Antenna Ports” process, is described below, including in process 300 of FIG. 3, according to various embodiments. The gNB RRC pre-configures, at step 302, CSI-RS resource mapping configurations with the largest number of ports for each of its configured CSI-RS resources in the CSI-ResourceConfig. The UE then determines the actual number of ports of that CSI-RS to measure. The number of ports is determined based on criteria known by both the UE and the gNB (e.g., RSRP thresholds). This method requires the gNB to indicate the maximum number of antenna ports to be reported, and requires the UE to indicate the number of antenna ports to report. Solution two may incur some waste, given the gNB always transmitting the largest number of ports, but the amount of waste may be smaller than that of the Preconfigured Set process, e.g., without the need for (pre)-configuring multiple CSI-RS resource mappings. More specifically, the Maximum Antenna Ports” process includes the following.

The UE is preconfigured by the gNB with one CSI-RS resource mapping configuration with the highest possible antenna port that gNB wants to assign to each of the configured CSI-RS resources in this specific UE or common for all UEs in the cell. Then, the UE measures and reports the RI, PMI and CQI of the configured CSI-RS resource mapping configuration to the gNB.

The UE continuously measures, at step 304, the quality of the existing link. For example, the UE may measure the RSRP or RSRQ or SINR of a subset of the SSB signals or a subset of configured 1 or 2 port CSI-RS signals within the NZP-CSI-RS-ResourceSet of the CSI-reportConfig with reportQuantity set to “cri-RSRP” or “ssb-Index-RSRP”, or the RSSI over a pre-defined measurement time window. There may be different ways to determine the subset of SSB signals or CSI-RS signals for RSRP measurement. For example, the gNB may explicitly indicate this subset to a UE via RRC configuration, and there may be a one-to-one mapping between a CSI-RS or SSB used for RSRP/RSRQ/SINR evaluation and a CSI-RS in each CSI-ReportConfig for RI/PMI/CQI reporting. In this way, for evaluating RSRP/RSRQ/SINR, the UE will only measure the corresponding CSI-RS or SSB signal which is mapped to a CSI-RS signal used for RI/CQI/PMI reporting.

Alternatively, a UE may implicitly utilize source QCL-RS of CSI-RS in each report config for RI/PMI/CQI reporting as the one for evaluation of RSRP/RSRQ/SINR. In this case, a UE may expect that there is only one source QCL-RS in each CSI-RS resource set used for RI/PMI/CQI reporting. Or, if there are multiple sources QCL-RS in each CSI-RS resource set e.g., in the mTRP scenario, the UE will evaluate the RSRP/RSRQ/SINR of the multiple source RSs for each of the possible mTRP transmission hypotheses. For CSI-RSRP determination, CSI reference signals transmitted on antenna port 3000 according to TS 38.211 may be used. If CSI-RSRP is used for L1-RSRP, CSI reference signals transmitted on antenna ports 3000, 3001 may be used for CSI-RSRP determination. The RSSI includes the linear average of the total received power (in watts (W)) observed only in configured OFDM symbols and in the configured measurement bandwidth over N resource blocks corresponding to measurement bandwidth with the center frequency of configured ARFCN, by the UE from all sources, including, for example, co-channel serving and non-serving cells, adjacent channel interference, and thermal noise.

At step 306, the UE determines whether the measured value is larger than a threshold. If the measured value is larger than a threshold, the UE reselects, at step 308, another or multiple CSI-RS resource mapping configurations with a lower number of antenna ports for measurement and reporting. The UE may continue this reselection of CSI-RS resource mapping configurations until the measured value is equal to the threshold. In order to report the selected CSI-RS resource mapping configurations, the reportQuantity IE in CSI-report Config IE may have added to it an additional element named “Selected CSI-RS resource mapping configuration index”. Alternatively, if the measured value is lower than a threshold, the UE reselects, at step 310, one or multiple CSI-RS resource mapping configurations with a higher number of antenna ports than the existing CSI-RS resource mapping configuration.

Alternatively, to save UE power consumption, when the measured RSRP/RSRQ/SINR is either lower or larger than a threshold, the UE continues the CSI measurement and reporting via the existing CSI-RS resource mapping configuration.

Alternatively, if the measured rank indicator (RI) in the selected CRI of either SSB or CSI-RS is larger than the previous reported one, the UE reselects one or more than one CSI-RS resource mapping configurations with a higher number of antenna ports than the existing CSI-RS resource mapping configuration. Otherwise, if measured rank indicator in the selected CRI is smaller than the previous reported one, then UE reselects one or more than one CSI-RS resource mapping configurations with a lower number of antenna ports than the existing CSI-RS resource mapping configuration.

Alternatively, if the measured RSSI is larger than a threshold, it may indicate that the cell load may be higher than before. Thus, the UE reselects one or more than one CSI-RS resource mapping configurations with a higher number of antenna ports than the existing CSI-RS resource mapping configuration. Otherwise, if the measured RSSI is smaller than the threshold, it may indicate that the cell load may be smaller than before. Then the UE reselects one or more than one CSI-RS resource mapping configurations with a lower number of antenna ports than the existing CSI-RS resource mapping configuration. Otherwise, if the measured RSSI is close to or equal to the threshold, the UE continues measuring the existing CSI-RS resource mapping configuration.

Alternatively, UE measures the network load via the number of REs or RBs where the measured RSRP is larger than a threshold. If the number of such REs or RBs are larger than the percentage of the total measured REs/RBs, it may indicate that the cell load may be higher than before. Then, the UE performs the same behavior as the one in the previous paragraph to adapt the CSI-RS resource mapping configuration with a different number of antenna ports.

Upon receiving a CSI-report of all serving UEs, the gNB acts to adapt the antenna ports, and possibly activate/re-configure each of the UEs with new CSI-RS resource mapping configurations.

As mentioned above, one of the embodiments of the Maximum Antenna Ports process is illustrated in FIG. 3 (which shows an enhanced CSI report solution (the Maximum Antenna Ports process) based on measured RSRP), where the enhanced CSI report is based on UE measured RSRP of SSB or existing CSI-RS signal.

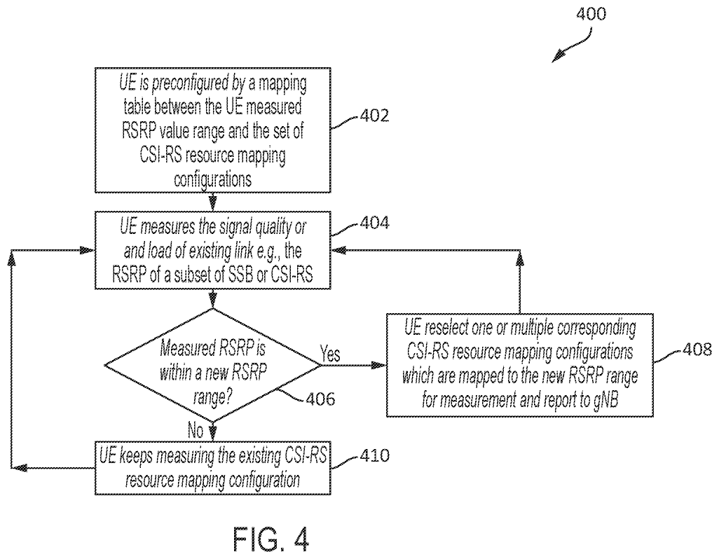

A solution referred to herein as a “Mapping Table” process, is described below, including in process 400 of FIG. 4, according to various embodiments. For each gNB there is a pre-defined mapping table between (i) the UE-measured CSI-RS or SSB SINR/RSRQ/RSRQ or RSSI value range of a subset of the SSB signals or a subset of configured 1 or 2 port CSI-RS signals within the NZP-CSI-RS-ResourceSet of the CSI-reportConfig with reportQuantity set to “cri-RSRP” or “ssb-Index-RSRP and (ii) the set of CSI-RS resource mapping configurations used for CSI-RS signal for RI/PMI/CQI reporting. After the UE measures CSI-RS or SSB SINR/RSRQ/RSRQ or RSSI of a subset of the SSB signals or a subset of configured 1 or 2 port CSI-RS signals within the NZP-CSI-RS-ResourceSet of the CSI-reportConfig with reportQuantity set to “cri-RSRP” or “ssb-Index-RSRP, according to the mapping table, the UE may select, for the RI/PMI/CQI report, one or multiple corresponding CSI-RS resource mapping configurations which are mapped to (i) the measured CSI-RS or SSB SINR/RSRQ/RSRP or RSSI values of the subset of the SSB signals or to (ii) a subset of configured 1 or 2 port CSI-RS signals within the NZP-CSI-RS-ResourceSet of the CSI-reportConfig with reportQuantity set to “cri-RSRP” or “ssb-Index-RSRP. The subset of SSB or CSI-RS signals is determined according to the methods indicated in the Preconfigured Set process or the Maximum Antenna Ports process.

For example, one example of the mapping table may be as follows:
RSRP range 1: CSI-RS resource mapping configuration 1, CSI-RS resource mapping configuration 2
RSRP range 2: CSI-RS resource mapping configuration 2, CSI-RS resource mapping configuration 3
. . .
RSRP range N−1: CSI-RS resource mapping configuration N, CSI-RS resource mapping configuration N
RSRP range N: CSI-RS resource mapping configuration N, CSI-RS resource mapping configuration N+1

The details of the procedure of the Mapping Table process are as follows. At step 402, the UE is configured by the gNB with a mapping table between the SINR/RSRP/RSRQ or RSSI value range of a subset of SSB or CSI-RS signals and the set of CSI-RS resource mapping configurations for RI/PMI/CQI reporting. This configuration may be done by RRC signaling. The UE initially selects or is assigned by the gNB one CSI-RS resource mapping configuration from the table, based on the existing measured SINR/RSRQ/RSRP or RSSI values of a subset of SSB or 1 or 2 ports CSI-RS signal. Initially, the UE measures and reports the RI, PMI and CQI by using the configured CSI-RS resource mapping configuration.

The UE continuously measures, at step 404, the quality of the existing link. For example, the UE may measure the RSRP and/or RSRQ and/or SINR of a subset of the SSB signals or a subset of configured 1 or 2 port CSI-RS signals within the NZP-CSI-RS-ResourceSet of the CSI-reportConfig with reportQuantity set to “cri-RSRP” or “ssb-Index-RSRP”, or the RSSI over a pre-defined measurement time window. There may be different ways to determine the subset of SSB signals or CSI-RS signals for RSRP measurement. For example, the gNB may explicitly indicate this subset to a UE via RRC configuration, and there may be a one-to-one mapping between a CSI-RS or SSB used for RSRP/RSRQ/SINR evaluation and a CSI-RS in each CSI-ReportConfig for RI/PMI/CQI reporting. In this way, the UE will only measure the corresponding CSI-RS or SSB signal for evaluating RSRP/RSRQ/SINR which is mapped to a CSI-RS signal used for RI/CQI/PMI reporting. Alternatively, a UE may implicitly utilize source QCL-RS of CSI-RS in each report configuration for RI/PMI/CQI reporting as the source QCL-RS for evaluation of RSRP/RSRQ/SINR. In this case, a UE may expect that there is only one source QCL-RS in each CSI-RS resource set used for RI/PMI/CQI reporting. Alternatively, if there are multiple source QCL-RSs in each CSI-RS resource set e.g., in the mTRP scenario, UE will evaluate the RSRP/RSRQ/SINR of the multiple source RSs for each of the possible mTRP transmission hypotheses. For CSI-RSRP determination, CSI reference signals transmitted on antenna port 3000 according to TS 38.211 may be used. If CSI-RSRP is used for L1-RSRP, CSI reference signals transmitted on antenna ports 3000, 3001 may be used for CSI-RSRP determination. RSSI (Received Signal Strength Indicator), includes the linear average of the total received power (in watts (W)) observed only in configured OFDM symbols and in the configured measurement bandwidth over N resource blocks corresponding to measurement bandwidth with the center frequency of configured ARFCN, by the UE from all sources, including, for example, co-channel serving and non-serving cells, adjacent channel interference, and thermal noise.

If, as determined at step 406, the measured value is within another new range in the mapping table, then the UE reselects, at step 408, another or multiple CSI-RS resource mapping configurations that correspond(s) to the new range in the mapping table and reports them to the gNB. In order to report the selected CSI-RS resource mapping configurations, the reportQuantity IE in CSI-report Config IE may have added to it an additional element named “Selected CSI-RS resource mapping configuration index”. Otherwise, if the measured RSRP/RSRQ/SINR of the SSB and CSI-RS is still within the existing range of values in the mapping table, the UE, at step 410, continues using the existing CSI-RS resource mapping configuration.

Alternatively, if measured RSSI or RI is within a new range in the mapping table, it may indicate that the cell load has significantly changed. Thus, UE reselects one or more CSI-RS resource mapping configuration that corresponds to the new range in the mapping table and reports them to gNB. Otherwise, if the measured RSSI or RI is still within the existing range of values in the mapping table, the UE continues using the existing CSI-RS resource mapping configuration.

Upon receiving CSI-reports of all serving UEs, the gNB acts to adapt the antenna ports, and possibly activate or re-configure each of the UEs with new CSI-RS resource mapping configurations.

As mentioned above, one of the embodiments of the Mapping Table process above is illustrated in FIG. 4 (which shows an enhanced CSI reporting solution (the Mapping Table process) based on measured RSRP), where the enhanced CSI report is based on UE-measured RSRP of a subset of SSB or CSI-RS signals, where the “subset” is determined using the same method as in the Preconfigured Set process and the Maximum Antenna Ports process.

New methods for efficient configuring and activating CSI-RS resource mapping configuration may include the following.

Instead of the UE self-adapting the CSI-RS resource mapping with a different number of antenna ports, the gNB may also dynamically change the CSI-RS resource mapping to a different number of antenna ports at each serving UE, e.g., based on the legacy UE measurement and reporting, or in combination with UE self-adapting the CSI-RS resource mapping with a different number of antenna ports.

In the legacy specification, the CSI-RS resourceMapping per CSI-RS resource is RRC pre-configured in the CSI-ResourceConfig of the CSI-ReportConfig. One way to change the resource mapping dynamically, if re-using the legacy specification, is to define a large number of CSI-ReportConfig to cover all possible antenna port patterns per CSI-RS resource for each UE and allow the gNB to activates one of the CSI-ReportConfig, via DCI 0_1, dynamically. However, since the DCI 0_1 only has a limited size and may only indicate up to 64 different CSI-ReportConfig, it may be impractical to preconfigure and dynamically indicate a large number of CSI-ReportConfig per UE, considering the fact that each CSI-RS resource may have up to 18 different types of CSI-RS resource mappings and there may be up to 64 CSI-RS resources per NZP-CSI-RS-ResourceSet.

A more efficient approach may be to keep the legacy CSI-reportConfig and directly dynamically change the “resourceMapping” field in CSI-ResourceConfig. For A-CSI report, a set of specific A-CSI triggering states for dynamic antenna port adaptation among the total 64 trigger states may be defined. Each of these states may have one or more CSI-reportConfig(s) and their corresponding CSI-ResourceConfig(s). Each of the NZP-CSI-RS-Resources in the CSI-ResourceConfig may have a dynamically changing “resourceMapping” field, depending on the gNB's dynamic antenna port adaptation.

The dynamic indication of the “resourceMapping” field in the CSI-RS resource set may be via an additional codepoint in the DCI 0_1, or it may be a new group common DCI, or a new MAC CE, or a new RRC re-configuration. If not too frequent, RRC reconfiguration may be suitable.

In case of a new RRC configuration, either the same resource mapping for all CSI-RS resources in the CSI-reportConfig or different resource mapping per CSI-RS resource in the CSI-reportConfig may be configured.

Alternatively, DCI, e.g., additional bits in DCI 0_1 may be used to indicate a new CSI-RS resource mapping that is identical for all CSI-RS resources in the CSI-reportConfig. DCI may not indicate a different resource mapping per CSI-RS resource because it may not be practical due to the limited size of DCI. The DCI may be a group common DCI which is used to indicate the CSI-RS resource configuration for a group of UEs.

Alternatively, in case of MAC CE, the MAC CE may activate/deactivate as well as indicate a new CSI-RS resource mapping which is identical for all CSI-RS resources in the CSI-reportConfig, or different resource mapping per CSI-RS resource in the CSI-reportConfig.

The field of UE-Group BWP switching is also included in the group common DCI or UE specific DCI where each BWP is pre-defined associated with a set of CSI-RS resource configurations with a different number of antenna ports. The bandwidth part indicator may be 0, 1, or 2, and determined by BandwidthPart-Config in higher layer message and Table 7.3.1.1.2-1 of TS 38.212.

Joint antenna port and mTRP adaptation may proceed as follows. For the mTRP deployment scenario, a goal may be to implement a joint antenna port adaptation across mTRPs including the possibility of muting the entire mTRP. For joint antenna port and mTRP adaptation, the key difference with antenna port adaptation for the single TRP case is that the pair of CSI-RS resources for channel measurement may have two different Transmission Configuration Indication (TCI) states, each corresponding to a TRP in the hypothesis of non-coherent joint transmission (NC-JT). In addition, the link quality measurement may involve multiple links each of which is associated with each TRP.

By reusing the legacy Rel-17, firstly, the UE needs to measure different single TRP or mTRP CSI-RS resources or resource pair(s) configured in CSI-RS-ResourceSet by assuming different corresponding CSI transmission hypotheses (e.g., single TRP1, single TRP2, joint TRP1 and TRP2). Secondly, the UE may also self-adapt, measure, and report the dynamic CSI-RS resource mapping with a different number of antenna ports per TRP, depending on the situation, e.g., link condition per TRP or load per TRP.

In a method referred to herein as Method 1, the UE is pre-configured with a CSI-RS-ResourceSet where the first X CSI-RS resources with a different number of antenna ports are assigned for TRP1, the second Y CSI-RS resources with a different number of antenna ports are assigned for TRP2, and the last Z CSI-RS resource pairs with a different number of antenna ports are assigned for NCJT TRP1 and TRP2. Each CSI-RS resource of single TRP or resource pair of NCJT is associated with a unique CRI index. The UE may measure and report one or multiple CSI-RS resources or resources pairs (CRI indexes), which corresponds to either single TRP or NCJT CSI hypothesis with a given number of antenna ports. In a method referred to herein as Method 2, the UE is pre-configured with a CSI-RS-ResourceSet where the first CSI-RS resources with the possible largest number of antenna ports are assigned for TRP1, the CSI-RS resources with the possible largest number of antenna ports are assigned for TRP2, and the last CSI-RS resource pair with the possible largest number of antenna ports are assigned for NCJT TRP1 and TRP2.

For the single TRP CSI hypothesis, the link quality assessment and the antenna port adaptation are based on evaluating or measuring one or two ports CSI-RS signal or SSB signal used for RSRP/RSRQ/SINR measurement transmitted per TRP. For NCJT transmission, the UE may determine which CSI-RS resource mapping with the number of antenna ports may be used for Channel Measurement Resource (CMR) resource pair per TRP. This may be a joint decision including measurement of both TRPs. For example, the UE continuously measures the quality of the link per TRP. For example, the UE may measure the RSRP and/or RSRQ and/or SINR of a subset of the SSB signals or a subset of configured 1 or 2 port CSI-RS signals per TRP within the NZP-CSI-RS-ResourceSet of the CSI-reportConfig with reportQuantity set to “cri-RSRP” or “ssb-Index-RSRP”. There may be different ways to determine the subset of SSB signals or CSI-RS signals for RSRP measurement per TRP. For example, the gNB may explicitly indicate this subset to a UE via RRC configuration, and there may be a one-to-one mapping between a CSI-RS or SSB used for RSRP/RSRQ/SINR evaluation and a CSI-RS in each CSI-ReportConfig for RI/PMI/CQI reporting. In this way, the UE will only measure the corresponding CSI-RS or SSB signal for evaluating RSRP/RSRQ/SINR which is mapped to a CSI-RS signal used for RI/CQI/PMI reporting. Alternatively, a UE may implicitly utilize source QCL-RS of CSI-RS in each report configuration for RI/PMI/CQI reporting as the one for evaluation of RSRP/RSRQ/SINR. In this case, a UE may expect that there is only one source QCL-RS in each CSI-RS resource used for RI/PMI/CQI reporting per TRP.

If the link quality between UE and a TRP1 in terms of measured RSRP/RSRQ of the subset of the one or two port CSI-RS signals used for RSRP/RSRQ/SINR reporting is lower than a pre-defined threshold (referred to herein as threshold1), the UE reselects another CSI-RS resource mapping of this TRP with a higher number of antenna ports for measurement and reports to this TRP1, such that the link quality may be improved in terms of RSRP.

If the link quality of a first TRP, TRP1, in terms of measured RSRP/RSRQ of the subset of the one or two port CSI-RS signal used for RSRP/RSRQ/SINR reporting is less than a pre-defined threshold (referred to herein as threshold2) (with threshold2<threshold1), whereas the link quality of another TRP, TRP2, in terms of measured RSRP is larger than a pre-defined threshold (referred to herein as threshold 3), the UE then may switch to single TRP2 operation and report it to TRP1 and TRP2 via the specific CRI value which corresponds to single TRP2 operation for a given CSI-RS resource with a particular CSI-RS resource mapping.

If one link quality of a TRP1 in terms of measured RSRP/RSRQ of the subset of the one or two port CSI-RS signal used for RSRP/RSRQ/SINR reporting is larger than a pre-defined threshold4, UE reselects another CSI-RS resource mapping of this TRP with a lower number of antenna ports for measurement and report to this TRP1, such that the un-used antenna ports may be switched off for network energy saving.

If the link quality of TRP1 in terms of measured RSRP is between A and B, whereas the link quality of TRP2 in terms of measured RSRP is between C and D, then there is a predefined mapping of a pair of the CSI-RS resource mappings to be used for the link to TRP1 and the link to TRP2. The UE reselects this pair of the CSI-RS resource mappings for measurement and reports it to TRP1 and TRP2.

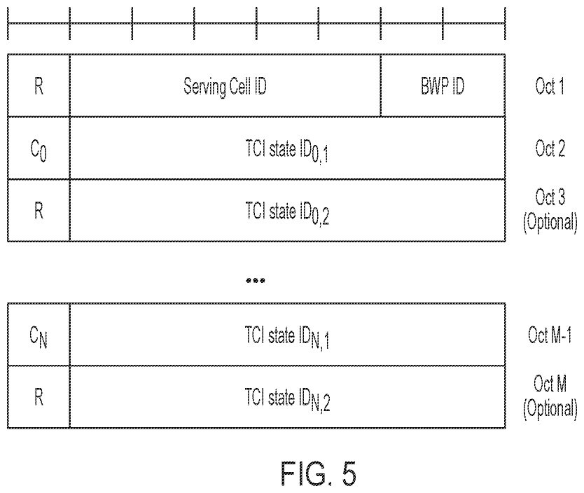

To summarize, instead of being statically configured with CSI-RS resource mapping as in Rel-17, the CSI-RS resource pair for NCJT with two TRPs may be dynamically changed to minimize the network energy consumption while maintaining the quality of the link, depending on the traffic load, the link condition etc. Thus, for a given K1, K2, M1, M2, N values, there is a predefined set of possible CSI-RS resource mappings configured by the network to the serving UE for each CMR group and/or CMR pair, such that UE may dynamically select to optimize network energy consumption. The reported CRI to gNB indicates the selected CSI-RS resource mapping as well as the CSI transmission hypothesis. This is illustrated in FIG. 5.

For the Rel. 16/17 schemes (if supported), the same DMRS port(s) may be associated with up to two TCI states. This may be interpreted as an implicit indication/switching between the Rel. 17 mTRP scheme and the legacy (defined in Rel-15) single TRP scheme. With the reuse of Rel. 17 enhanced TCI states activation/deactivation MAC CE structure, as shown in FIG. 5, each codepoint of the TCI field in a DCI for UE-specific PDSCH is mapped to up to two TCI states. With this structure if Ci=0 (i.e., the TCI codepoint in the DCI indicates a TCI state ID that only has one mapped TCI state), a PDSCH transmission is single TRP, and if Ci=1 (i.e., the TCI codepoint in the DCI indicate a TCI state ID that has two mapped TCI states), a PDSCH transmission uses the Rel. 17 mTRP scheme. To enable efficient joint antenna port and TRP adaptation, a group common DCI may be introduced to allow a group of serving UEs of a given TRP to perform a fast switch from single TRP to mTRP and vice versa by indicating single or two TCI states in this group common DCI.

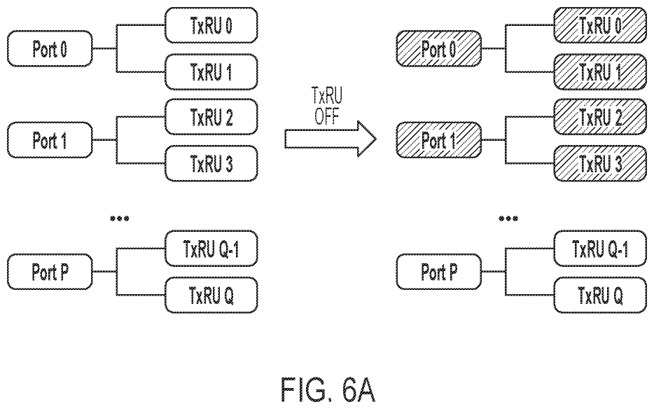

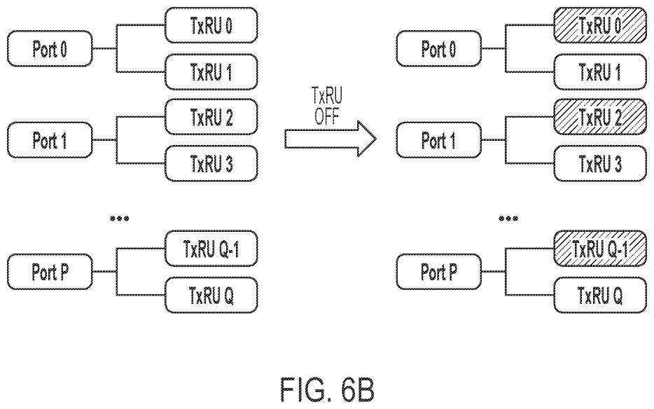

Alternatively, to enable efficient joint antenna port and TRP adaptation, a group common DCI may be introduced to allow a group of serving UEs of a given TRP fast switch from mTRP with one given pair of CSI-RS resource mappings to mTRP with another pair of CSI-RS resource mappings and vice versa, by indicating the selected pair of CSI-RS resource mappings in this group common DCI. This is illustrated in FIGS. 6A and 6B for Type 1 and Type 2, respectively.

TxRU adaptation when the number of antenna ports does not change may be performed as follows. L1 signaling of the TxRU muting pattern to inform UE to make measurement(s) and generate report(s) based on the CSI-RS transmitted after TxRU adaptation, when mapping between logical antenna port to gNB TxRU(s) is updated.

The gNB RRC pre-configures CSI-RS resource mapping configurations with a set of TxRU muting patterns where each of the TxRU patterns has an index value and is mapped to one or multiple CSI-RS resource mappings. The UE then determines, or is requested by the network, the actual one or more TxRU patterns to measure and report, each corresponding to a CSI-RS resource mapping. The TxRU pattern to measure and report may be determined based on known criteria by both the UE and the gNB (e.g., RSRP thresholds of the measured SSB signal). In principle, the procedure described above for antenna port muting may be re-used for TxRU muting, where the TxRU muting pattern may be signaled or pre-configured to the UE instead of antenna port muting patterns. Since the legacy specification only deals with antenna port, to maintain the legacy CSI-RS resource mapping and legacy antenna port configurations, one specific TxRU pattern may be signaled and identified by both a bitmap of the antenna ports (active=1, inactive=0) and a bitmap of TxRUs (active=1, inactive=0).

Light-weighted methods that allow the UE to provide CSI feedback for different ports or TxRU muting patterns may be performed as follows. Some embodiments include light-weighted methods for providing CSI feedback with respect to the antenna port or TxRU muting pattern adaptation. Instead of a full CSI-report of PMI/RI/CQI/CRI, a simple feedback is enough for the gNB to make the decision regarding muting pattern information (e.g., indices) and their relative quality (e.g., relative throughput (t-put)/SINR loss/gain compared to a baseline). In particular, the reportQuantity may be enhanced as follows (e.g., by the addition of the three SpatialMuting parameters).

```
reportQuantity CHOICE {
    none NULL,
    cri-RI-PMI-CQI NULL,
    cri-RI-i1   NULL,
    cri-RI-i1-CQI   SEQUENCE {
    pdsch-BundleSizeForCSI   ENUMERATED {n2, n4} OPTIONAL
    },
    cri-RI-CQI   NULL,
    cri-RSRP   NULL,
    ssb-Index-RSRP   NULL,
    cri-RI-LI-PMI-CQI   NULL
SpatialMuting-Relative-Tput   NULL,
SpatialMuting-Relative-SINRloss   NULL,
SpatialMuting-Relative-SINRGain   NULL,
},
```

In particular, the UE may feed the following information back to the gNB as a new type of UE assistant information to gNB, which may be carried via UCI PUCCH or PUSCH:

| | SpatialMuting- | SpatialMuting- | SpatialMuting- |
|---|---|---|---|
| | Relative-Tput | Relative-SINRloss | Relative-SINRgain |
| Spatial muting | A1 | B1 | C1 |
| pattern 1 | | | |
| Spatial muting | A2 | B2 | C2 |
| pattern 2 | | | |
| Spatial muting | A3 | B3 | C3 |
| pattern 3 | | | |
| Spatial muting | A4 | B4 | C4 |
| pattern 4 | | | |

Spatial adaptation only for PDSCH but not references signals may be performed as follows. The main idea is to use few antennas for data transmission whenever possible, while maintaining some reference signal transmissions in the background on more antennas for reference signal measurements, in order to facilitate accurate dynamic adaptation. It may be advantageous that the antenna muting applies differently to data channel PDSCH and control channel/CSI-RS. When some antennas are off, PDSCH cannot be transmitted via these transceivers. However, the gNB may still transmit CSI-RS over the muted transceivers occasionally (i.e., the muted transceivers may turn on in a very short time just for CSI-RS transmission) so that the gNB knows whether it is necessary to turn those transceivers back on. When to transmit CSI-RS via the muted transceivers may be event based, e.g., based on the change of current CSI feedback (whether it deteriorates significantly) or change of traffic conditions in the network. Such assistance from the UEs may already be possible in the form of CSI reporting framework, but the efficiency of providing assistance in this manner may be low.

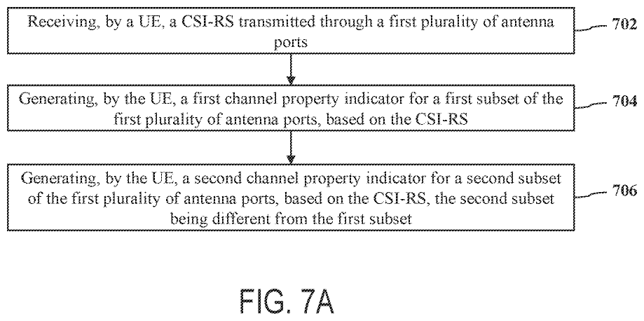

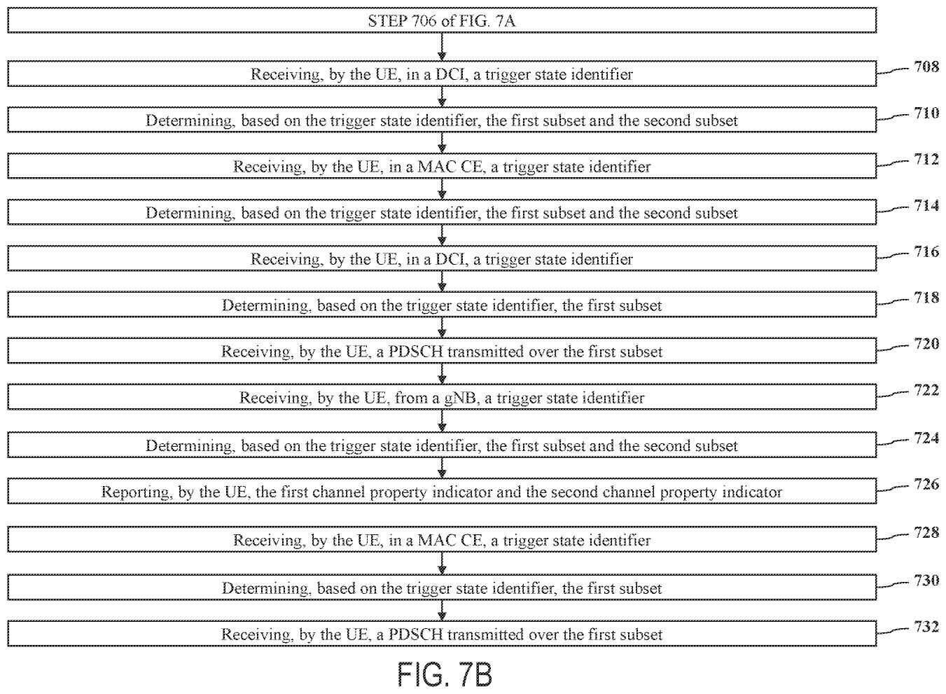

FIG. 7A is a flowchart of a method, in some embodiments. The method includes receiving, by a UE, at 702, a CSI-RS transmitted through a first plurality of antenna ports; generating, by the UE, at 704, a first channel property indicator for a first subset of the first plurality of antenna ports, based on the CSI-RS; and generating, by the UE, at 706, a second channel property indicator for a second subset of the first plurality of antenna ports, based on the CSI-RS. The second subset may be different from the first subset. For example, the CSI report configuration may include several (e.g., three) sub-configurations (e.g., a first sub-configuration with 32 antenna ports, a second sub-configuration with 16 antenna ports, and a third sub-configuration with 8 antenna ports), and the CSI-RS may be transmitted through a plurality of antenna ports (e.g., 32 antenna ports). The UE may then measure or calculate a first channel property indicator for a first subset of the plurality of antenna ports (e.g., for the 16 antenna ports of the second sub-configuration) and the UE may also measure or calculate a second channel property indicator for a second subset of the first plurality of antenna ports (e.g., for the 8 antenna ports of the third sub-configuration).

FIG. 7B is a flowchart of a method, in some embodiments. Optionally, as depicted in FIG. 7B, the process at step 706 may then further proceed to step 708, wherein the UE receives, in a DCI, a trigger state identifier. The method may further include determining, at 710, based on the trigger state identifier, the first subset and the second subset. The method may further include receiving, by the UE, at 712, in a MAC CE, a trigger state identifier; and determining, at 714, based on the trigger state identifier, the first subset and the second subset. The method may further include receiving, by the UE, at 716, in a DCI, a trigger state identifier; determining, at 718, based on the trigger state identifier, the first subset; and receiving, by the UE, at 720, a PDSCH transmitted over the first subset. The method may further include receiving, by the UE, at 722, from a gNB, a trigger state identifier; determining, at 724, based on the trigger state identifier, the first subset and the second subset; and reporting, at 726, by the UE, the first channel property indicator and the second channel property indicator. The method may further include receiving, by the UE, at 728, in a MAC CE, a trigger state identifier; determining, at 730, based on the trigger state identifier, the first subset; and receiving, at 732, by the UE, a PDSCH transmitted over the first subset.

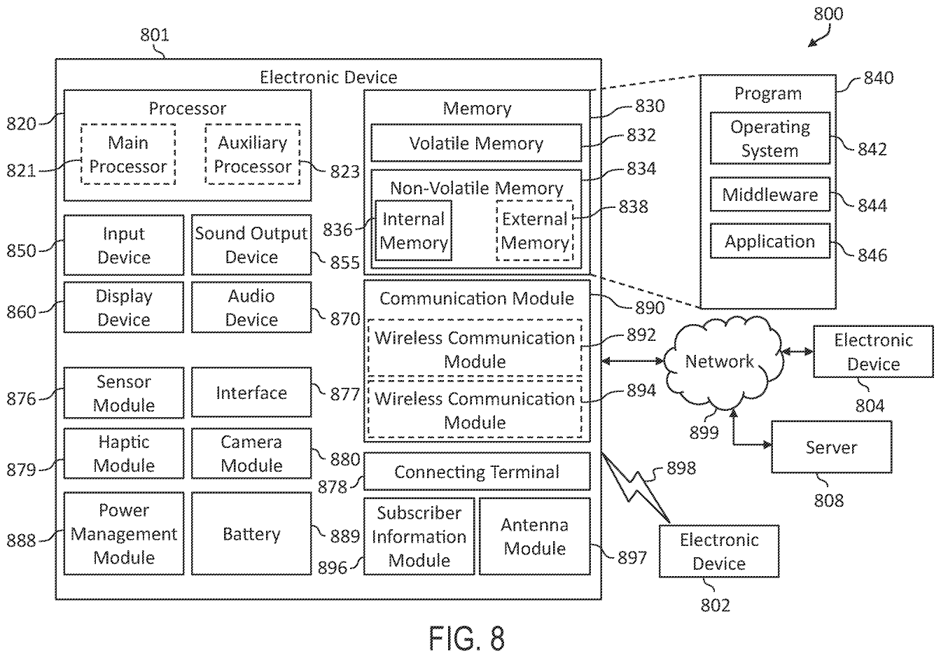

FIG. 8 is a block diagram of an electronic device 801 in a network environment 800, according to an embodiment. The network device 801 may perform some or all of the methods disclosed herein. Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 840, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 894. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 846 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally, or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as Bluetooth™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively, or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
receiving, by a User Equipment (UE), a Channel State Information reference signal (CSI-RS) transmitted through a first plurality of antenna ports;
generating, by the UE, a first channel property indicator for a first subset of the first plurality of antenna ports, based on the CSI-RS; and
generating, by the UE, a second channel property indicator for a second subset of the first plurality of antenna ports, based on the CSI-RS,
wherein the second subset is different from the first subset.

2. The method of claim 1, wherein the first subset is associated with an index.

3. The method of claim 1, further comprising:
receiving, by the UE, in a Downlink Control Information (DCI), a trigger state identifier; and
determining, based on the trigger state identifier, the first subset and the second subset.

4. The method of claim 3, wherein the DCI is a group common DCI.

5. The method of claim 3, wherein the UE is preconfigured with an association mapping the trigger state identifier to the first subset and the second subset.

6. The method of claim 1, further comprising:
receiving, by the UE, in a Media Access Control Control Element (MAC CE), a trigger state identifier; and
determining, based on the trigger state identifier, the first subset and the second subset.

7. The method of claim 6, wherein the UE is preconfigured with an association mapping the trigger state identifier to the first subset and the second subset.

8. The method of claim 1, further comprising:
receiving, by the UE, in a Downlink Control Information (DCI), a trigger state identifier;
determining, based on the trigger state identifier, the first subset; and
receiving, by the UE, a Physical Downlink Shared Channel (PDSCH) transmitted over the first subset.

9. The method of claim 1, further comprising:
receiving, by the UE, from a network node (gNB), a trigger state identifier;
determining, based on the trigger state identifier, the first subset and the second subset; and
reporting, by the UE, the first channel property indicator and the second channel property indicator.

10. The method of claim 1, further comprising:
receiving, by the UE, in a Media Access Control control element (MAC CE), a trigger state identifier;
determining, based on the trigger state identifier, the first subset; and
receiving, by the UE, a Physical Downlink Shared Channel (PDSCH) transmitted over the first subset.

11. A User Equipment (UE) comprising:
one or more processors; and
a memory storing instructions which, when executed by the one or more processors, cause performance of:
receiving a Channel State Information reference signal (CSI-RS) transmitted through a first plurality of antenna ports;
calculating a first channel property indicator for a first subset of the first plurality of antenna ports, based on the CSI-RS; and
calculating a second channel property indicator for a second subset of the first plurality of antenna ports, based on the CSI-RS,
wherein the second subset is different from the first subset.

12. The UE of claim 11, wherein the first subset is associated with an index.

13. The UE of claim 11, wherein the instructions, when executed by the one or more processors, further cause performance of:
receiving, by the UE, in a Downlink Control Information (DCI), a trigger state identifier; and
determining, based on the trigger state identifier, the first subset and the second subset.

14. The UE of claim 13, wherein the DCI is a group common DCI.

15. The UE of claim 13, wherein the UE is preconfigured with an association mapping the trigger state identifier to the first subset and the second subset.

16. The UE of claim 11, wherein the instructions, when executed by the one or more processors, further cause performance of:
receiving, by the UE, in a Media Access Control control element (MAC CE), a trigger state identifier; and
determining, based on the trigger state identifier, the first subset and the second subset.

17. The UE of claim 16, wherein the UE is preconfigured with an association mapping the trigger state identifier to the first subset and the second subset.

18. The UE of claim 11, wherein the instructions, when executed by the one or more processors, further cause performance of:
receiving, by the UE, in a Downlink Control Information (DCI), a trigger state identifier;
determining, based on the trigger state identifier, the first subset; and
receiving, by the UE, a Physical Downlink Shared Channel (PDSCH) transmitted over the first subset.

19. The UE of claim 11, wherein the instructions, when executed by the one or more processors, further cause performance of:
receiving, by the UE, from a network node (gNB), a trigger state identifier;
determining, based on the trigger state identifier, the first subset and the second subset; and
reporting, by the UE, the first channel property indicator and the second channel property indicator.

20. A User Equipment (UE) comprising:
means for processing; and
a memory storing instructions which, when executed by the means for processing, cause performance of:
receiving a Channel State Information reference signal (CSI-RS) transmitted through a first plurality of antenna ports;
calculating a first channel property indicator for a first subset of the first plurality of antenna ports, based on the CSI-RS; and
calculating a second channel property indicator for a second subset of the first plurality of antenna ports, based on the CSI-RS,
wherein the second subset is different from the first subset.
